(19) United States
(12) Patent Application Publication
(10) Pub. No.: US 2010/0007726 A1
(43) Pub. Date: Jan. 14, 2010

(54) METHOD AND APPARATUS FOR CLASSIFYING A PERSON

(75) Inventors: Mauro Barbieri, Eindhoven (NL); Johannes Weda, Eindhoven (NL); Lalitha Agnihotri, Tarrytown, NY (US); Marco Emanuele Campanella, Eindhoven (NL); Prarthana Shrestha, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/445,479

(22) PCT Filed: Oct. 17, 2007
(86) PCT No.: PCT/IB2007/054226

§ 371 Date: Apr. 14, 2009

(30) Foreign Application Priority Data
Oct. 19, 2006 (EP) 06122599.1

(51) Int. Cl. G06K 9/62; G06K 9/00; H04N 7/18

(52) U.S. Cl. 348/78; 382/117; 382/224; 704/246; 348/E07.085

(57) ABSTRACT

Photo or video content of a person is acquired (401). A dimension of at least one iris of a person such as radius of the iris is measured (405, 411). A dimension of the face of the person, such as width of the face, is measured. The person is then classified (413) as an adult or child on the basis of a ratio of the dimension of the face and the dimension of the iris.

### FIELD OF THE INVENTION

The present invention relates to method and apparatus for classifying a person on the basis of their facial features. In particular, but not exclusively, it relates to automatically detecting a child captured by an image.

### BACKGROUND OF THE INVENTION

Children are usually treated differently to adults in many different situations. For example, parental controls have been introduced in respect of many items such as televisions, computers, multimedia players so that the child will not be exposed to content of an adult nature. Further, some software programs have adjustable user interfaces so that if the actual user is a child the interface can be adjusted to a simpler interface or adapted to take into consideration particular interests and preferences of children.

Advertisements displayed in public areas such as shops, may be adjusted to take in account a child watching. Since children in particular represent an increasing and very important category of users, it is of major importance to tailor ambient intelligent systems to these potential customers.

Further applications may include controlling a device, such as an airbag to take into account the presence of a child.

Furthermore, in the storage domain, it is desirable that applications automatically compose summaries of photo collections or automatically edit home video. When a automatic video or still picture editing system composes a summary out of a family collection, in a lot of cases it is desirable that the summary focuses on children as the children are usually the main reason for shooting the video or taking pictures.

Many different solutions exist for identifying a child, which, invariably, require users to identify themselves (authentication) to the system, usually by means of entering a password or inserting a token (e.g. key). More sophisticated systems perform identification of the person based on biometric information (e.g. face, fingerprint, iris recognition). Once a person is recognized, the age can be looked-up from a user profile and appropriate action taken (such as authorization to view certain content or adapt user interfaces to the age of the user etc.). However, such systems are rather cumbersome and intrusive.

A known system for automatically categorizing a person by their age is disclosed by U.S. Pat. No. 5,781,650. The system involves a four-step process of finding facial features of a person captured by a digital image and calculating various facial feature ratios to categories the person.

However, in the applications mentioned above, it is important that the child is identified and that there is no misclassification of a child as a adult thus exposing a child to content of an adult nature or inappropriately activating an airbag for example. The facial feature ratios utilized in the categorization of U.S. Pat. No. 5,781,650 can be inaccurate and misclassifications may occur. This is unacceptable for some applications.

Further the techniques used to finding the facial features, calculating various ratios to categories the person is complex and requires increased processing power, and higher precision processing.

Furthermore the technique used in U.S. Pat. No. 5,781,650 can only distinguish between babies (until 3 years old), adults (from 3 until 40) and seniors (above 40). The latter category is detected by using wrinkle detection. Therefore, it is not capable of categorizing a person into finer categories.

### SUMMARY OF THE INVENTION

Therefore, it is desirable to provide a simple system which is robust for accurately classifying a child, not only babies but also children until approximately 11 years old, from an adult in a natural, non-intrusive way which avoids any misclassifications.

This is achieved, according to an aspect of the present invention, by a method for classifying a person, the method comprising the steps of: determining a dimension of at least one iris of a person; determining a dimension of the face of the person; and classifying the person on the basis of a ratio of the determined dimension of the face of the person and the determined dimension of the at least one iris of the person.

This is also achieved, according to another aspect of the present invention, by apparatus for classifying a person, the apparatus comprising: means for determining a dimension of at least one iris of a person; means for determining a dimension of the face of the person; and a classifier for classifying the person on the basis of a ratio of the determined dimension of the face of the person and the determined dimension of the at least one iris of the person.

The size of the iris of a newborn child is fixed and does not significantly change in size as the child grows to an adult. However, the head of a child does change in size, until the child is fully grown. This means that the ratio facial dimension to iris dimension represents an accurate measure for the distinction between children and adults. Please note that the term ‘adult’ in this context refers to people from age group of puberty and older; a human that from a medical or physical point of view has left its childhood.

Furthermore the distinction between children and adults can be simply achieved, in accordance with a preferred embodiment, by comparing the ratio of the determined dimension of the face and the determined dimension of the iris does not exceed a predefined threshold. As a result of using the ratio of the dimensions of the face and the iris it is almost impossible for a child to be misclassified as adult making the system more effective.

Preferably, the classification also takes into account skin color, iris color, voice pitch and/or content of speech of the person to increase the accuracy of the determination.

In a preferred embodiment, the dimension of an iris of a person is determined by locating an area of the face of the person occupied by the eyes of the person, iteratively locating at least one edge sections of said at least one iris of said person in said located area; estimating a circle including said at least two edge sections; and determining a dimension of said circle, such as the radius of the circle.

The dimension of the face of the person may be the distance between the eyes of the person and/or the width of an area enclosing the face of the person.

### BRIEF DESCRIPTION OF DRAWINGS

For a more complete understanding of the present invention, reference is now made to the following description taken in conjunction with the accompanying drawings in which:

FIG. 1 is a simple schematic block diagram of apparatus according to a first embodiment of the present invention;

FIG. 2 is a flow chart of the steps of the method according to the first embodiment of the present invention;

FIG. 3 is a simple schematic block diagram of the apparatus according to another embodiment of the present invention;

FIG. 4 is a flow chart of the steps of the method according to the another embodiment of the present invention; and

FIGS. 5 to 7c illustrate pictorial results at various stages of the method according to another embodiment of the present invention.

### DETAILED DESCRIPTION OF EMBODIMENTS OF THE INVENTION

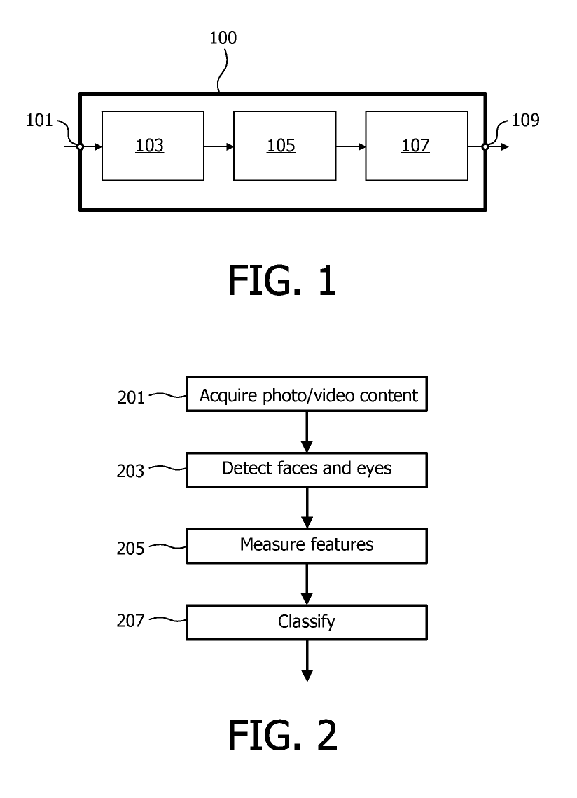

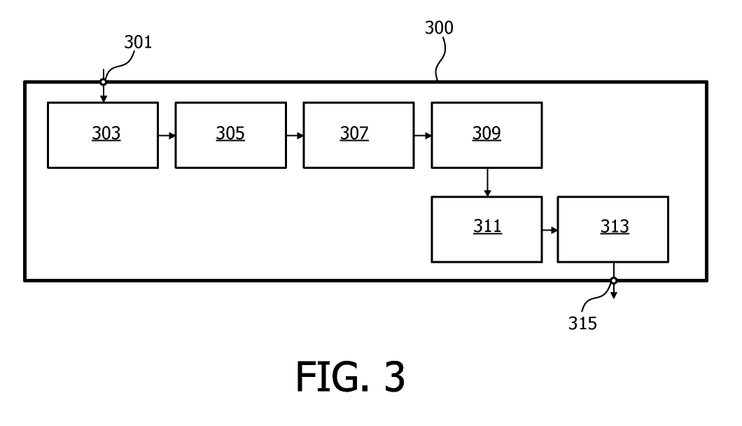

With reference to FIGS. 1 and 2 a first embodiment will be described in detail.

The apparatus 100 comprises an input terminal 101 connected to the input of a face/eyes detector 103. The face/eyes detector 103 is connected to a feature analyzer 105. The feature analyzer 105 is connected to a classifier 107. The output of the classifier 107 is connected to an output terminal 109 of the apparatus 100. Operation of the apparatus 100 will now be described in more detail with reference to FIG. 2.

In step 201a photo or video content is acquired and input on the input terminal 101 of the apparatus 100. The faces and the corresponding eyes/irises of persons captured by the input content are detected, step 203, by the detector 103. The detector 103 comprises one of many known types of detectors that automatically detect faces and eyes which are commercially available.

The detected faces and irises are then analyzed, step 205, by the feature analyzer 105. The analysis comprises determining the dimensions of the faces and irises. This analysis may be based on the output of the face/eye detector 103 directly. Alternatively, an independent algorithm can be developed which determines the dimensions based on one or more of the following features: edges, skin color, iris color, eye features (pupil, iris edge, etc.) and face features (mouth, nose, eyes, ears, hair, etc.).

In the next step, step 207, the ratio of the determined dimensions of the face to iris is computed and used to classify the content accordingly by the classifier 107. In a simple embodiment the classifier 107 compares the ratio to a predefined threshold. If the ratio is above the predefined threshold the face is classified as belonging to an adult, otherwise to a child. The results are then output on the output terminal 109 of the apparatus 100.

In an alternative embodiment, the classifier 107 is based on more accurate pattern classification methods such as neural networks, support-vector machines, or Bayesian classifiers.

The accuracy of the apparatus can be further improved by classification on the basis of additional ratios: such as of the ratio of the distance between eyes and the determined dimension of the iris and the ratio of a determined dimension of the face based on skin color to the determined dimension of the iris.

Skin color segmentation can be used to have a more precise measurement of the face size. After the segmentation, we measure the width of the face instead of relying on the information on face size provided by the face detection only.

The fact that the inner and outer boundaries of the human iris have known colors (white for the limbus and black for the pupil) and the iris itself has a limited set of hues', can be used to improve the accuracy of the iris detection.

Additionally, audio features such as the high voice pitch can be used in conjunction with the ratios mentioned above. Furthermore a “child audio classifier” may be utilized, which is trained on child gibberish vs. regular speech, and its results used as additional features.

Although it is possible for the apparatus of the embodiment of the present invention for an adult to be misclassified as child if, for example, the eyes are pointing both towards the nose, but it is almost impossible for a child to be misclassified as adult. The latter property is required for most applications. If audio features are used accuracy is further improved.

The accuracy of the method is influenced by the position of the head. For example, the distance between the eyes reduces if the picture or the video does not show the person frontal. This problem can be solved in two ways: use a face detector which exclusively works on frontal faces, or use an multi-pose face detector, obtain the rotation angle of the face from the face detector, and use this information to compensate for the rotation.

Alternatively a plurality of images may be captured, for example a video sequence, from the plurality of images, an image can be selected in which the person is shown in a “best” position, namely frontal.

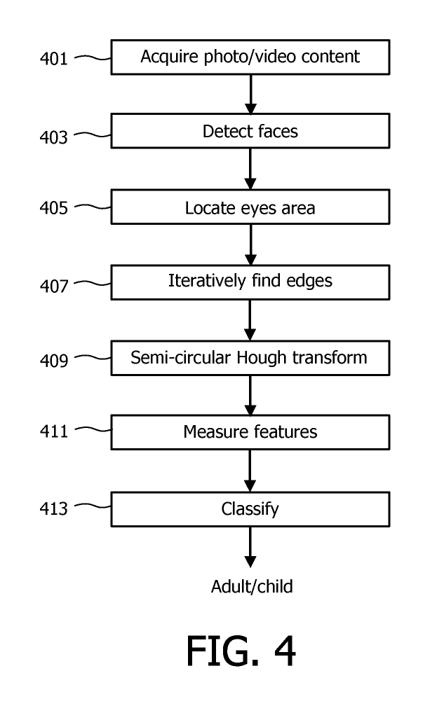

A further embodiment will be described with reference to FIGS. 3 to 7c.

With reference to FIG. 3, the apparatus 300 comprises an input terminal 301. The input terminal 301 is connected to the input of a face detector 303. The output of the face detector 303 is connected to eyes area filter 305. The output of the filter 305 is connected to an iterative edge detector 307. The output of the iterative edge detector 307 is connected to a semi-circular Hough transform 309. The output of the semi-circular Hough transform 309 is connected to a feature analyzer 311. The feature analyzer 311 is also connected to a classifier 313. The output of the classifier 313 is connected to an output terminal 315.

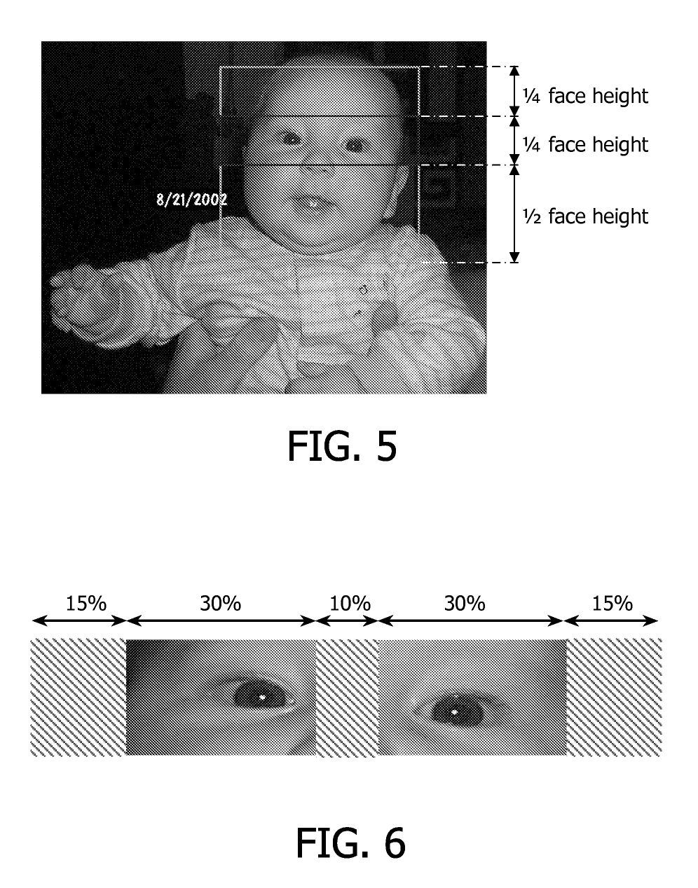

Operation of the apparatus will now be described in detail with reference to FIGS. 4 to 7c.

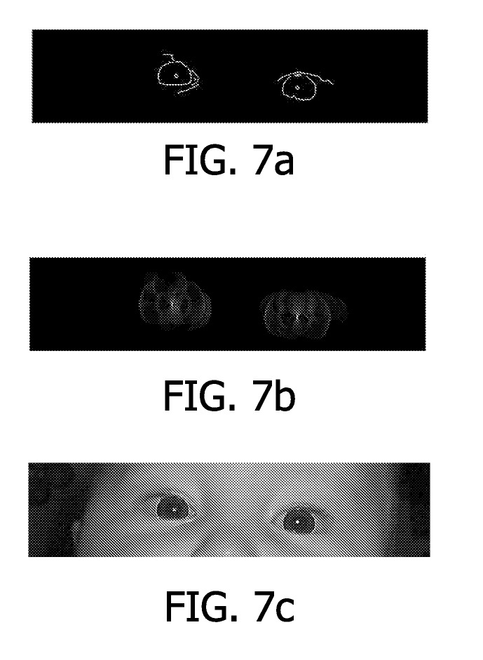

As described with reference to the first embodiment first step 401, photo/video content is acquired and input on the input terminal 301 of the apparatus 300. Using known techniques, the faces of the persons captured by the photo or video content is detected, step 403, by the face detector 303. This is applied to locate faces in the content. The output of the face detector 301 consists of the coordinates of a square around the face. This is forwarded to the eye area filter 305 where the eyes area is located, step 405, by taking a rectangle out of the square with the same width as the square, and with a quarter of the height of the square. The top of the rectangle is located a quarter height below the top of the square. This procedure is graphically shown in FIG. 5.

To speed-up computation, further filtering of the eye area is carried out. The rectangle around both eyes is reduced to two smaller rectangles around each eye. This is done by removing 10% of the centre of the rectangle around the eyes, and 15% of the left and right side of the rectangle. This procedure is graphically shown in FIG. 6.

In the next step 407, a known ‘Canny’ edge detector 307 is used to locate the edges of the irises. Since some digital images have much stronger edges than others, the edge detector is iteratively applied with lower thresholds until a specified amount of edges has been found. This procedure results in enough edges to find significant structures in the image, and it prevents too many edges being found, which would unnecessarily complicate the numerical procedure. The iterative application of the edge detector makes the algorithm more robust. The output of the edge detector 307 consists of a binary image as shown in FIG. 7a.

On the binary image of FIG. 7a delivered by the edge detector 307, a semi-circular Hough transform is performed, step 409, by the semi-circular Hough transform 309. The Hough transform is a standard algorithm that is used to find a specific structure (line, circle, etc) in an image as shown in FIG. 7b which shows the ‘Hough space’, resulting from the transform. In a preferred embodiment, the semi-circular Hough transform is applied to find and determine a dimension of the irises. Since the top and bottom part of the iris is often (partially) occluded, the semi-circular Hough transform is modified to put more emphasis on the left and right part of the iris. One way that this is achieved is using only the “vertical” arcs from −45° till 45° and from 135° till 225°.

An example of the procedure from the binary image to detected irises is shown in FIG. 7c.

From the detected irises, the centre co ordinates are determined and the radius can easily be determined, step 411, by the analyzer 311, thus providing the iris size. The dimension of the face is determined from the distance between the two detected irises, and/or from the width of the square provided by the face detector. A linear combination of the two measures for the face size can be applied. Instead of comparing the ratio of face size and iris radius to a threshold, a linear combination of the two ratios can be utilized:

A*faces_size/iris_radius+B*eyes_distance/iris_radius>T

where A and B are parameters that can be determined using examples of adults and children and T is a threshold. Standard methods can be used to determine the “optimal” A and B parameters such as linear classifiers theory, or Bayesian classification theory.

As described with reference to the first embodiment above, the ratios of the determined dimension of the face and the determined dimension of the iris is computed and used to classify the person, step 413, by the classifier 313 by comparing the ratio with a predefined threshold. If the ratio is above the predefined threshold outputting on the output terminal 315 of the apparatus 300 an indication that the face belongs to an adult, otherwise it belongs to a child. If the linear combination is applied, then if the linear combination of the two face sizes divided by the iris radius is above a certain threshold, the face is classified as belonging to an adult, otherwise to a child.

The system according to the preferred embodiment provides an accurate and simple method for categories a person. In tests, 91 to 92% of children were correctly identified and 76 to 93% of adults.

The apparatus of the present invention may be utilized in numerous systems.

Children are often the “subjects” of digital photographs and home videos. In preparing a photo slide show or editing home video, usually parents would like to focus on them and select mainly or only content in which they are present. Automatic children detection can be used to automatically compose a photo slide show or edit home video footage centered on children.

Shop windows and billboards for advertisements can be equipped with a digital video camera to observe the people that are passing by and looking at the advertisement. The advertisement can be adapted in case children are detected among the viewers to target directly the children or their parents. Here in addition to the irises, the height of the person can be used. The camera can be calibrated to know the height of the person depending on the location of the eyes. Since knowing the height of a person in an image can be difficult, for this application the relative heights of the detected faces can be used: children will in general stay below adult people.

To prevent damaging their eyes, very young babies should not be photographed using flashes. The method of the present invention can be used to disable the flash of digital cameras when young babies are detected in front of the camera. Alternatively a warning message can be shown in the display of the camera if a young baby is detected.

A content reproducing apparatus may be equipped with a digital (video) camera that detects whether among the viewers there is a child. In that case certain content or channels of an adult nature are disabled. Additionally the content reproducing apparatus could display automatically content that is suitable or meant specifically for children. Additionally, in cases in which the camera is fixed, height estimation can also be used.

Further, the method of the present invention can be used in physical locks and doors to prevent opening them when a child is detected. The lock or door can be equipped with a tiny digital camera and a system implementing the present invention. Permission to open the lock/door is denied to persons that are not classified as adult. Furthermore the threshold of the classifier can be changed, the lock/door can then be tuned to be more or less strict as the child grows.

Many electronic devices have user interfaces that can be adapted and simplified if children are using them. Examples are TV sets, PC's, DVD players, and automatic telling machines. Therefore, the user interface is adapted upon detection of child.

Special settings could also be applied for children in vehicles. For example the airbag activation sequence could be different if a child is detected in one of the seats. An additional feature that can be used here is the weight of the person in the seat measured using a pressure sensor to assist in detecting a child.

Medical environments or devices could be adapted automatically in case children are detected.

Some devices could disable some features for safety reasons. For example an electric oven or cooking plate could be equipped with the system of the embodiment of the present invention and be locked such that it can be activated by children. Vehicles and weapons could also be disabled if a child attempts to use them.

Restaurant menus, such as of e-paper could detect whether the customer is a child and adapt their content.

Detecting whether a subject in a digital video is a child or an adult could be useful in surveillance applications and stored along with security video in surveillance systems.

The method of the present invention could be applied as extra authentication test in existing authentication systems based on tokens or passwords. Examples of applications are credit card transactions, telephones, etc.

Automatic detection of children in digital images can be used to automatically scan large image and video databases that are suspected of hiding child porn content.

The present invention can be applied in image/video search engines to search and retrieve images/videos containing children.

Furthermore, detection of the human iris may be used in photographs. Sometimes people appear with their eyes completely or almost closed due to winking of the eyes. The iris detection method of the present invention can be applied to solve this problem. A digital still camera can take multiple successive shots and then automatically select the one in which the eyes of all subjects are open.

The size/ratio of iris/pupil and their responses under different stimulus are used for examining reflexes or consciousness level in cases such as determining children's growth, testing alcohol or drugs abuse, etc. The method of the present invention can be applied to medical procedures, which requires iris and pupil measurements.

Studies have shown that humans (especially females) are judged as more attractive if their pupils are wide open and more dilated than normal. The name Belladonna (beautiful lady) comes from the fabled use of the juices of the Nightshade plant by Italian women who would use eye drops in order to enlarge their pupils and make their eyes appear more beautiful. The method of the present invention can be used to determine the perfect size of a pupil and enhance beauty in a digital portrait.

Although preferred embodiments of the present invention have been illustrated in the accompanying drawings and described in the foregoing description, it will be understood that the invention is not limited to the embodiments disclosed but capable of numerous modifications without departing from the scope of the invention as set out in the following claims. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

‘Means’, as will be apparent to a person skilled in the art, are meant to include any hardware (such as separate or integrated circuits or electronic elements) or software (such as programs or parts of programs) which perform in operation or are designed to perform a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for classifying a person, the method comprising the steps of:
determining a dimension of at least one iris of a person;
determining a dimension of the face of said person; and
classifying said person on the basis of a ratio of said determined dimension of the face of said person and said determined dimension of said at least one iris of said person.

2. A method according to claim 1, wherein the step of classifying said person comprises:
identifying said person as a child or adult.

3. A method according to claim 2, wherein a child is identified if said ratio of said determined dimension of the face of said person and said determined dimension of said at least one iris of said person does not exceed a predefined threshold.

4. A method according to claim 1, wherein the method further comprises:
determining at least one of skin color, iris color, voice pitch and content of speech of said person; and wherein the step of classifying said person further comprises:
classifying said person on basis of at least one of determined skin color, iris color, voice pitch and content of speech of said person.

5. A method according to claim 1, wherein the step of determining a dimension of at least one iris of said person comprises:
locating an area of the face of said person occupied by the eyes of said person.

6. A method according to claim 5, wherein the step of determining a dimension of at least one iris of said person further comprises:
iteratively locating at least two edge sections of said at least one iris of said person in said located area;
estimating a circle including said at least one edge sections; and
determining a dimension of said circle.

7. A method according to claim 5, wherein the step of determining a dimension of the face of said person comprises:
determining a distance between the eyes of said person in said located area.

8. A method according to claim 5, wherein the step of determining a dimension of the face of said person comprises:
determining a width of an area enclosing the face of said person.

9. A method according to claim 1, wherein the method further comprises:
capturing a plurality of images of said person; and
selecting one of said plurality of images showing both eyes of said person; and
detecting the face of a person captured in said selected image.

10. A method according to claim 1, the step of determining a dimension of at least one iris of said person further comprises:
determining a radius of at least one iris of said detected face.

11. A method for controlling a device on the basis of the classification of a person, the classification being carried out by the method according to claim 1.

12. A computer program product comprising a plurality of program code portions for carrying out the method according to claim 1.

13. Apparatus for classifying a person, the apparatus comprising:
means for determining a dimension of at least one iris of a person;
means for determining a dimension of the face of said person; and
a classifier for classifying said person on the basis of a ratio of said determined dimension of the face of said person and said determined dimension of said at least one iris of said person.

14. Apparatus according to claim 13 further comprising means for capturing an image of said person and a detector for detecting the face of said person captured by said image.
